(19) United States
(12) Patent Application Publication
(10) Pub. No.: US 2006/0007790 A1
(43) Pub. Date: Jan. 12, 2006

(54) Magneto-optical device

(75) Inventor: Rudolf Johan Maria Vullers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,924

(22) PCT Filed: Oct. 6, 2003
(86) PCT No.: PCT/IB03/04409

§ 371 Date: Apr. 27, 2005

(30) Foreign Application Priority Data
Oct. 29, 2002 (EP) 02079524.1

(51) Int. Cl. G11B 11/00

(52) U.S. Cl. 369/13.01; 369/44.11

(57) ABSTRACT

In a magneto-optical device in which a laser (1) is directed through a coil (5) during operation, the coil itself is used as a measurement device for measuring the alignment of coil and laser by measuring the resistance of the coil as a function of the alignment of coil and laser beam.

The invention relates to a magneto-optical device comprising a magneto-optical read and/or write head with a coil, and a means for generating a laser beam, wherein the laser beam is directed through an aperture in the coil during operation.

The invention also relates to a method of manufacturing a magneto-optical device comprising a magneto-optical read and/or write head with a coil, and a means for generating a laser beam, wherein the laser beam is directed through an aperture in the coil during operation, in which manufacturing step the laser beam and the coil are aligned.

The invention also relates to a method of checking or tuning a magneto-optical device comprising a magneto-optical read and/or write head with a coil, and a means for generating a laser beam, wherein the laser beam is directed through an aperture in the coil during operation.

A magneto-optical device of the type described in the opening paragraph is known from International Patent Application WO 01/82299. In such devices, optical recording techniques are combined with a magneto-optical head that is brought close to a recording layer on a disk in operation. Polarized laser light is used to read and write on the disk. The laser beam is directed through an aperture in a coil which is incorporated, for example, on a slider or on an actuator. A proper alignment of the laser beam and coil is important for a proper functioning of the head and the disk recorder. It is known to align the laser and the coil by means of interferometric devices and measurements. However, a special set-up and elements are required for said technique.

It is an object of the invention to provide a magneto-optical disk recorder and a method in which a simple, alternative technique is used.

To achieve this object the magneto-optical device comprises means for measuring the resistance of the coil and means for changing the alignment of the coil and laser beam and/or the focusing of the laser beam in dependence on the resistance of the coil, and the methods in accordance with the invention are characterized in that the resistance of the coil is measured while the laser beam is being directed through the aperture of the coil, and the alignment of the coil and laser beam and/or the focusing of the laser beam is checked or changed in dependence on the measured resistance of the coil, and/or the resistance of the coil is measured as the alignment of the coil and laser beam is being changed.

When a laser is not well aligned with respect to the coil—and/or not properly focused—part of the coil will be irradiated by the laser beam and heat up. The resistance of this part will change, particularly increase. Measuring the resistance of the coil while aligning and/or changing the focus of the laser beam and changing the alignment and/or focusing of the beam in dependence on the measured resistance renders it possible in a simple manner to find a good alignment and/or focus without requiring special set-ups.

Preferably, the optical disk recorder comprises a means for changing the position of the laser and coil in two transverse directions. In preferred embodiments of the method, the relative position of coil and laser beam is changed in two transverse directions. In this manner the center of the coil can be easily found.

In a preferred embodiment of the methods, the current during alignment is equal to or preferably lower than an operating current of the device. The risk of damaging the coil during alignment is reduced thereby. Preferably, the laser intensity during alignment is equal to or preferably lower than the operating laser intensity for the same reason.

The characterizing method step may be performed during manufacture of a disk recorder to improve in a simple manner the alignment of the coil and the laser prior to sale or use of a product, or may alternatively be used to tune or realign an already manufactured product, or simply to check a device and reject it or having it pass a check. In the latter case, if the measured resistance is outside a given range, the disk recorder is rejected or accepted. Rejects can then be discarded or realigned.

These and other aspects of the invention are apparent from and will be elucidated with reference to the embodiments described hereinafter.

In the drawings:

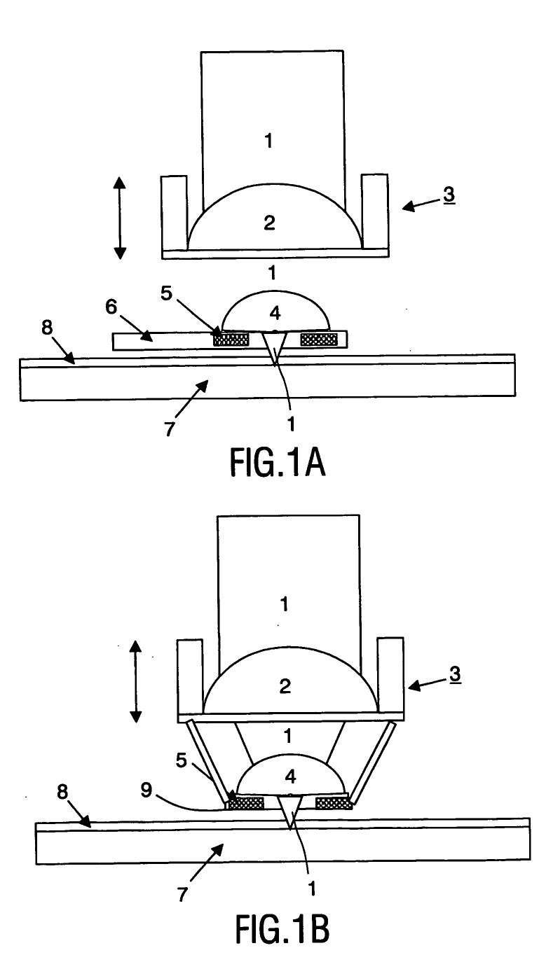

FIGS. 1A and 1B schematically illustrate two designs of heads for magneto-optical devices,

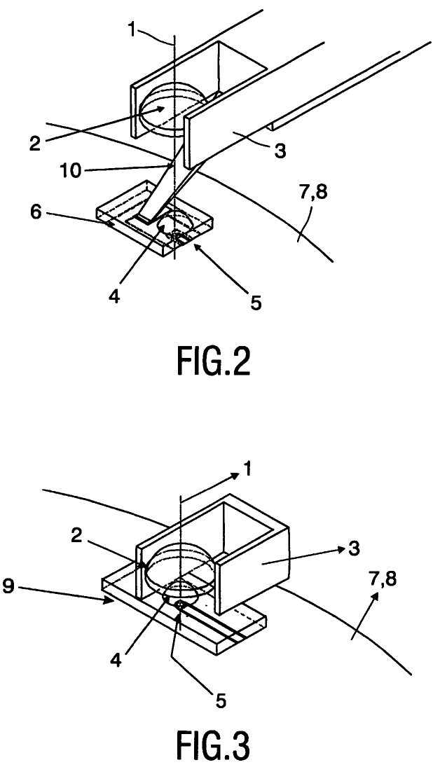

FIG. 2 schematically illustrates one of the designs of FIG. 1 in more detail,

FIG. 3 schematically illustrates one of the designs of FIG. 1 in more detail,

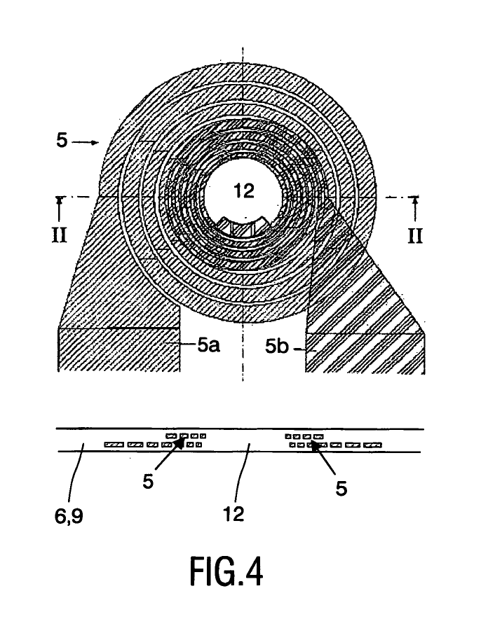

FIG. 4 gives a plan view of a coil showing the aperture through which a laser beam is directed during operation,

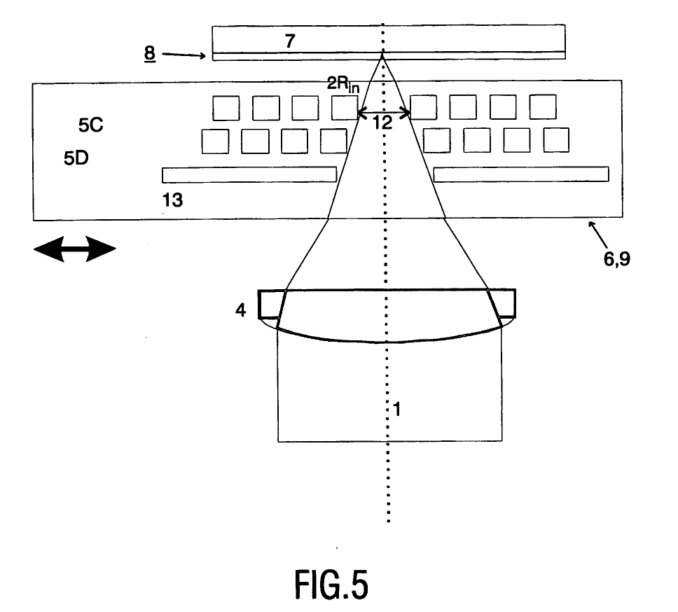

FIG. 5 schematically illustrates in cross-section the light path of a laser beam through the coil,

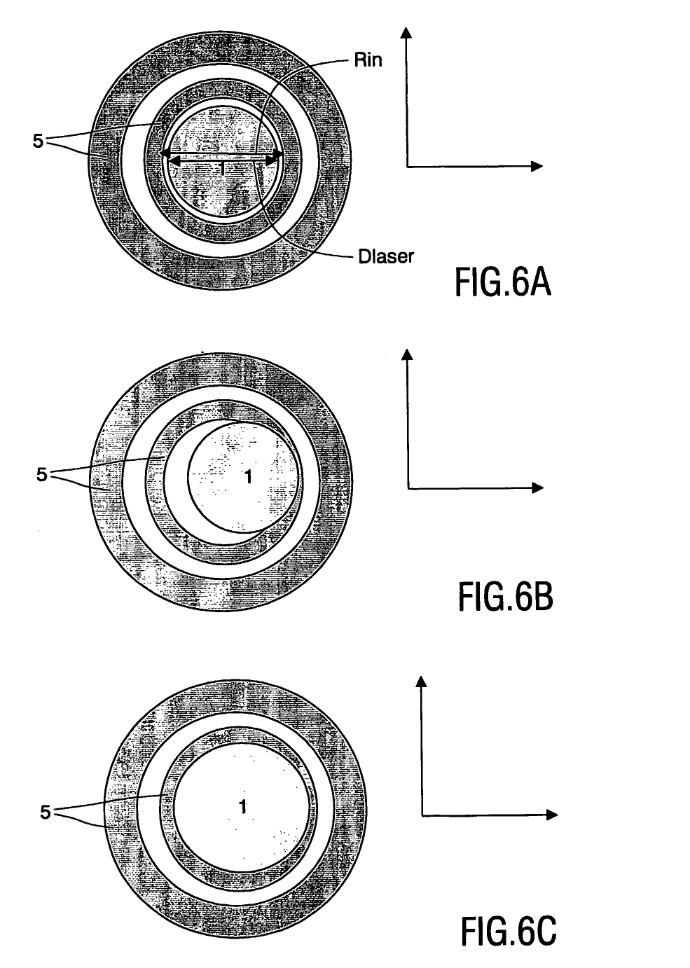

FIGS. 6A to 6C illustrate situations in which the laser beam is and is not well aligned and/or focused,

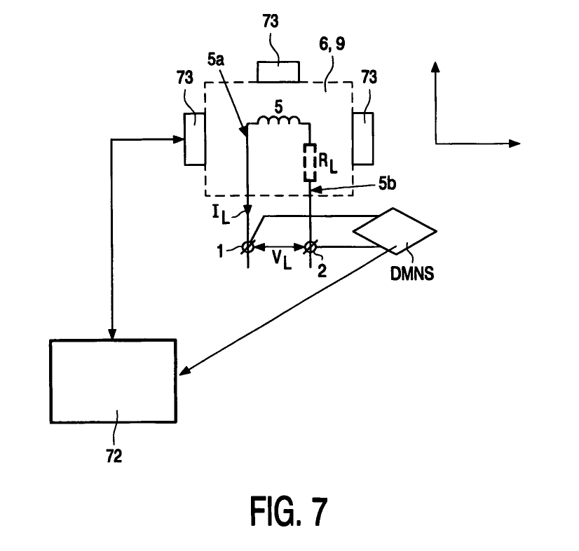

FIG. 7 illustrates schematically a possible electrical arrangement for the device in accordance with the invention or useable in the method in accordance with the invention,

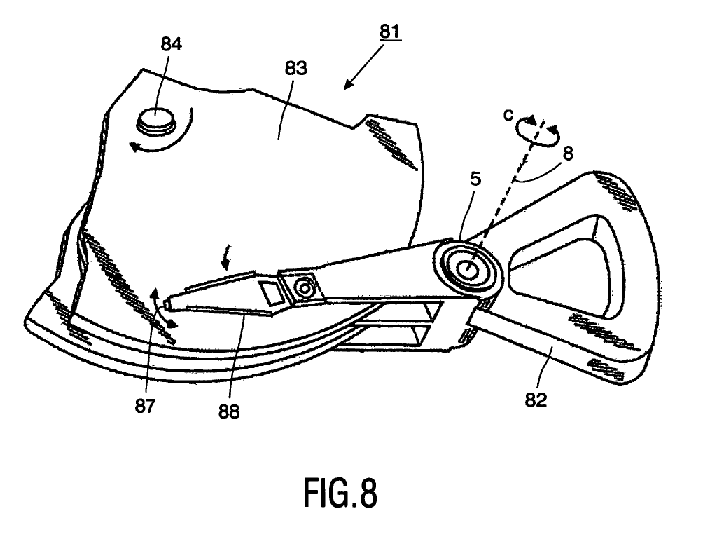

FIG. 8 schematically illustrates a part of an optical disk recorder,

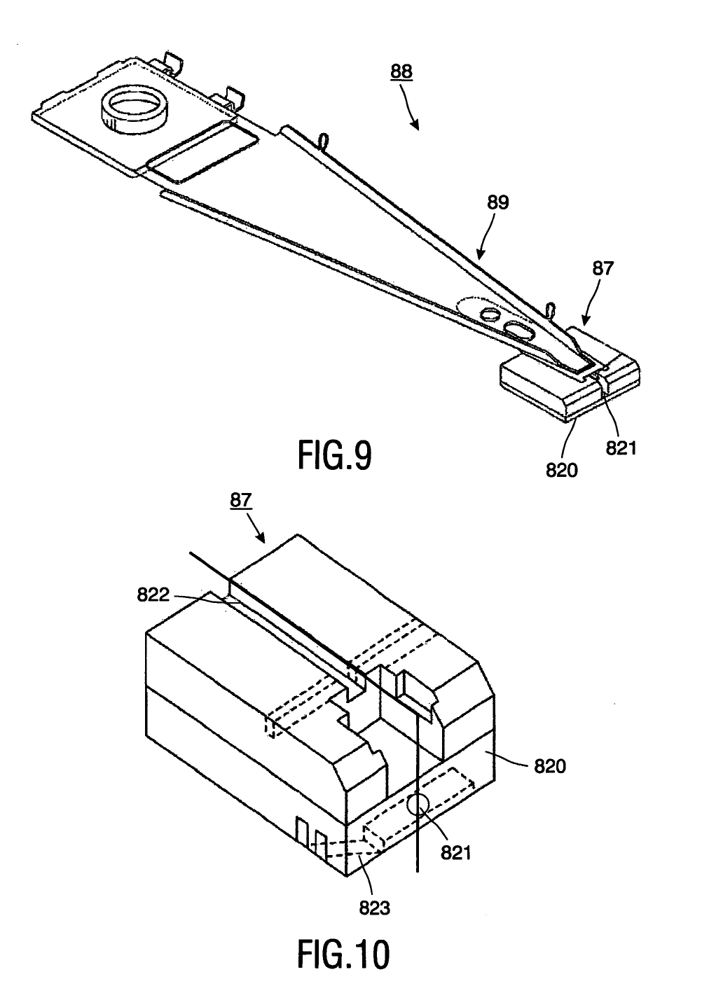

FIG. 9 schematically illustrates an arm of an optical disk recorder comprising a read and/or write head, and

FIG. 10 schematically illustrates a read and/or write head for an optical disk recorder.

The Figures are not drawn to scale. Generally, identical components are denoted by the same reference numerals in the Figures.

The present invention is applicable to each and any type of magneto-optical device having a read and/or write head and a laser which shines through a coil during operation. It is immaterial whether the magneto-optical device is of the so-called Near Field or Far Field type and whether or not use is made of a slider or of an actuator.

FIGS. 1A and 1B illustrate two types of arrangements. In both arrangements a beam from a laser source 1 is directed through an objective lens 2 on a holder 3 and through a second lens 4 during operation so as to be focused on a disk 7. The disk 7 is provided with a cover layer 8. The laser beam 1 is directed through a coil 5. FIG. 1A a shows a type of read and/or write head of the so-called slider type, in which the second lens 4 and coil 5 are provided on a slider 6. FIG. 1B shows a head of the so-called actuator type in which the lens 4 and coil 5 are provided on and/or in a glass wafer 9.

FIG. 2 shows a head of the type shown in FIG. 1A in more detail. The suspension 10 of the slider is shown in this Figure. FIG. 3 shows in somewhat more detail a head of the type shown in FIG. 1B.

In all types, the head comprises a coil 5. FIG. 4 shows a coil 5 in more detail. The coil comprises two leads 5a and 5b and an aperture 12 through which the laser beam is directed during operation. The coil is part of, applied on, or embedded in the slider 6 or wafer 9.

FIG. 5 schematically shows in cross-section a beam 1 shining through a lens 4 and a coil 5 having two coil layers 5C and 5D on or in a holder 6, 9. The coil comprises an aperture 12 through which the beam is passed. Schematically, the arrows next to the holder indicate that the relative position of the holder and beam, and thus of the beam 1, vis-à-vis the aperture 12 in the coil 5 may be changed. Such a change may be effected by changing the position of the holder or by changing the light path of the beam or a combination of both. To this end, for example, a movable mirror (e.g. movable by means of a piezoelectric means) or a movable holder (also e.g. movable by a piezoelectric means) may be provided in the device. During manufacture the actual position of the holder (in x-y direction, possibly also in z-direction) may be controlled, as may the light path, e.g. by the position and/or orientation of a movable mirror. As will be explained later, the resistance is measured as the position of the holder or the light path is changed. When a satisfactory situation has been obtained, the positions and or the light path is fixed. Alternatively or in addition, the focus may be changed, e.g. by a movable or in general controllable lens means. The holder may also comprise a magnetic layer 13 comprising a central aperture. The central aperture of the layer 13 is slightly larger than the central aperture of the coil. The laser shines on the disk 7, which may have an optional cover layer 8.

FIGS. 6A to 6C show various situations. In FIG. 6A the beam 1 is perfectly aligned and does not overlap the coil 5. The coil is part of the read and write head and is often embedded in glass, oxide, or a plastic substrate. This is not to be taken as a restriction, since the material of the substrate may be any suitable material as long as there is a transparent part or window through which the laser beam can pass. The diameter of the laser beam at the central aperture in the coil depends on various parameters, such as the thickness of the substrate, the free working distance of the head, the refractive index, the NA of the lens, and the disk composition. The coil has an inner diameter Rᵢₙ. The beam has a diameter Dₗₐₛₑᵣ. The beam should pass the aperture of the coil with a certain tolerance T. Thus Rᵢₙ≧Dₗₐₛₑᵣ+T.

If the coil comprises more than one layer or if a magnetic layer is used, the radius has to be determined at various z-positions, thus Rᵢₙ(z)≧Dₗₐₛₑᵣ(z)+T. The smaller Rᵢₙ, the greater the magnetic field that can be supplied by the coil, thus ideally Rᵢₙ is as closely as possible equal to Dₘₐₓ. If the laser beam is not well aligned with respect to the coil (FIG. 6B) or not well focused (FIG. 6C), part of the coil will be irradiated by the laser beam. Consequently, part of the beam will not hit the disk and the efficiency of the device is compromised.

The alignment could be done by means of interferometry, but this requires a special set-up.

The basic concept of the invention is to use the coil itself as an optical alignment means. The coils are made of metal (e.g. Cu) or another conducting material. The resistivity of the material of the coils is temperature-dependent, for metals such as Cu it increases with temperature. The irradiated part will heat up and the resistance of this part will change, for metals it will generally increase. By measuring the resistance of the coil while aligning, an increase of the resistance will be measured. This is used for aligning the beam and coil vis-à-vis each other. The Table below gives some parameters.

| Parameters | Min value | Max value |
|---|---|---|
| Thickness (μm) | 4 | 4 |
| Width of inner winding (μm) | 5 | 5 |
| Inner Radius Rᵢₙ (μm) | 40 | 80 |
| Incident laser on winding (mW) | 1 | 5 |
| Sense current (mA) | 50 | 150 |
| ΔV due to heating (μV) | 3 | 50 |
| Time constant (ms) | 10 | 50 |

The change in voltage due to heating was found to be several microvolts. This is large enough to be measured, since the noise is typically a few microvolts. The current needed is preferably chosen to be equal to or less than (as in the example of Table 1) the operating current of the coil, thus there will be no or only a small risk of damaging the coil while aligning.

The output signal ΔV is electrical and can be used to control the alignment, enabling the beam spot to be aligned in the center of the coil. By sweeping the coil in two transverse directions (an x and y direction), the coil center can be determined, once this is done the position of the coil is fixed. The focusing of the beam may also be changed. Too large a focus will cause the other edges of the beam to heat up the coil. The principle of using the resistance of the coil as a means for measuring overlap of beam and coil is used for (fine)-tuning the focusing of the beam in embodiments. This principle may also be used to check the position of a magnetic layer vis-à-vis the coil. If the magnetic layer is shifted in respect of the coil, a sweep of the laser beam in two directions will enable this fact to be established. No heating effect is observed were the coil is “hidden” behind the magnetic layer, a larger than expected heating effect is observed where the coil extends in the aperture in the magnetic layer. Thus by sweeping the laser beam over the aperture the relative position of the coil and magnetic layer can be determined.

FIG. 7 illustrates a possible electrical arrangement. A sensing current I₁ is sent through the coil 5 via the leads 5a, 5b. The series resistance of the coil is schematically indicated by R₁. The voltage V₁ is measured by detecting means DMNS at a given sensing current I₁. The coil holder is provided with means 73 for changing the x-y position. The detection means DMNS send the signal V₁ to a control unit 72, which also has an input for a position signal from the means 73. The control unit comprises a means, which may comprise, for example, a program, for measuring the signal V₁ as a function of the position signal(s) and to determine an extremum (maximum or minimum) as a function of the x- and y-positions. This indicates an optimal position of the holder. The holder is brought to said optimal position and is fixed in said position. In this manner the coil and the beam are aligned. Preferably, the optical device comprises a means for changing the position of the laser and coil in two mutually transverse directions. In preferred embodiments of the method, the relative position of coil and laser beam is changed in two mutually transverse directions. In this manner the center of the aperture 12 in the coil 5 can be easily found.

In embodiments of the invention, the device is provided with means DMNS and, when the device is manufactured and/or during the life time of the device, a check is made of the alignment and, if needed, the alignment of coil and laser beam is adjusted.

In method embodiments of the invention, the method step of changing the alignment of the coil and laser beam and simultaneously recording the change of the resistance is performed. This may be done, for example, by changing temporarily the alignment and thereafter fixing the position of the coil and laser optics. This may take place, for example, during manufacture of the device. In such embodiments, the manufactured device itself need not be provided with means DMNS and/or means 73. Such means are then temporarily provided during manufacture. In the examples given above, the alignment is changed. However, it is also possible to change the focusing of the laser beam. As the focus of the beam is changed, the shape of the laser beam is changed and more or less light will hit the coil. This will cause a change in resistance of the coil, which can be detected. In embodiments in which a magnetic layer 13 is provided, a sweep of the laser beam across the aperture may reveal information on the mutual positions of magnetic layer 13 and coil 5.

In short the invention can be described as follows:

In a magneto-optical device in which a laser beam is directed through a coil during operation, the coil itself is used as a measurement device for measuring the alignment of coil and laser by measuring the resistance of the coil as a function of the alignment of coil and laser beam.

It will be appreciated by persons skilled in the art that the present invention is not limited by what has been particularly shown and described above. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention may be used in various devices, some of which are illustrated in FIGS. 8, 9 and 10, which should not, however, be taken as forming a restriction on the scope of the invention.

FIG. 8 illustrates a disk drive 81 comprising a head stack assembly 82 and a stack of spaced-apart magnetic data storage disks or media 83 that are rotatable about a common shaft 84. The head stack assembly 82 is rotatable about an actuator axis 85 in the direction of the arrow C. The head stack assembly 82 includes a number of actuator arms, only three of which are illustrated, which extend into spacings between the disks 83. A read and/or write head 87 is located at the end of the actuator arms.

The head stack assembly 82 further comprises an E-shaped block and a magnetic rotor 820 attached to the block in a position diametrically opposite to the actuator arms. The rotor cooperates with a stator (not shown) for rotating in an arc about the actuator axis 85. Energizing a coil of the rotor with a direct current in one polarity or the reverse polarity causes the head stack assembly 82, including the actuator arms, to rotate about the actuator axis 6 in a direction substantially radial to the disks 83.

A head gimbal assembly (HGA) 88 is secured to each of the actuator arms. With reference to FIG. 9, the HGA 88 is comprised of a suspension 89 and a read/write head 87. The suspension 89 comprises a resilient load beam and a flexure to which the head 87 is secured.

In general, the head 87 may comprise a slider body (or slider) secured to the free end of the load beam by means of the flexure, and it comprises a coil plate or coil holder 20 (FIG. 3). The coil plate comprises a coil or coil assembly 821 for generating a desired write magnetic field. The coil 821 is formed on (or within) a second (or bottom) side of the coil plate. The light path of a laser beam 822 is schematically shown. The laser beam is directed through the coil 821. The laser beam may be guided through optical waveguides, and mirrors may be provided to steer the laser beam 822. Electrical leads 823 are schematically indicated. These leads provide current to the coil 821. FIG. 10 schematically illustrates a head 87 in some more detail.

1. Magneto-optical device comprising a magneto-optical read and/or write head with a coil (5), and a means for generating a laser beam (1), wherein the laser beam is directed through an aperture (12) in the coil (5) during operation, characterized in that the optical disk recorder comprises means (DMNS) for measuring the resistance (R_{L}) of the coil (5) and means (73) for changing the alignment of the coil and laser beam and/or the focusing of the laser beam in dependence on the resistance of the coil.

2. Magneto-optical device as claimed in claim 1, characterized in that the optical disk recorder comprises means for changing the position of the laser and coil in two mutually transverse directions.

3. Method of manufacturing a magneto-optical device comprising a magneto-optical read and/or write head with a coil (5), and a means for generating a laser beam (1), wherein the laser beam is directed through an aperture (12) in the coil (5) during operation, in which manufacturing step the laser beam and the coil are aligned, characterized in that the resistance (R_{L}) of the coil (5) is measured while the laser beam is being passed through the aperture of the coil, and the alignment of the coil and laser beam and/or the focusing of the laser beam is checked or changed in dependence on the measured resistance of the coil, and/or the resistance of the coil is measured as the alignment of the coil and laser beam is being changed.

4. Method of checking or tuning a magneto-optical device comprising a magneto-optical read and/or write head with a coil (5), and a means for generating a laser beam (1), wherein the laser beam is directed through an aperture (12) in the coil (5) during operation, characterized in that the resistance (R_{L}) of the coil (5) is measured while the laser beam is being passed through the aperture of the coil, and the alignment of the coil and laser beam and/or the focusing of the laser beam is checked or changed in dependence on the measured resistance of the coil, and/or the resistance of the coil is measured as the alignment of the coil and laser beam is being changed.

5. Method as claimed in claim 3, characterized in that the relative position of coil and laser beam is changed in two mutually transverse directions.

6. Method as claimed in claim 3, characterized in that the current intensity during alignment, checking, or tuning is equal to or preferably lower than an operating current of the device.
